(19) United States
(12) Patent Application Publication
(10) Pub. No.: US 2021/0015690 A1
(43) Pub. Date: Jan. 21, 2021

(54) FALL PREVENTION SAFETY WHEELCHAIR BRAKE DEVICE

(71) Applicant: Young Bae YOU, Yangju-si, Gyeonggi-do (KR)

(72) Inventor: Young Bae YOU, Yangju-si, Gyeonggi-do (KR)

(21) Appl. No.: 16/982,594

(22) PCT Filed: Mar. 22, 2019
(86) PCT No.: PCT/KR2019/003354

§ 371 Date: Sep. 21, 2020

(30) Foreign Application Priority Data
Mar. 22, 2018 (KR) 10-2018-0033463

(51) Int. Cl. A61G 5/10

(52) U.S. Cl. CPC A61G 5/1005; A61G 2200/34; A61G 2203/70

(57) ABSTRACT

The present invention relates to a fall prevention safety wheelchair brake device, and more particularly, in a wheelchair having a safety bar for preventing a safety accident due to a fall while moving the wheelchair, to a fall prevention safety wheelchair brake device in which a brake is locked when the safety bar is not fastened, and the brake is switched from a locked state to an unlocked state when the safety bar is fastened.

### TECHNICAL FIELD

The present invention relates to a fall prevention safety wheelchair brake device, and more particularly, in a wheelchair having a safety bar for preventing a safety accident due to a fall while moving the wheelchair, to a fall prevention safety wheelchair brake device in which a brake is locked when the safety bar is not fastened, and the brake is switched from a locked state to an unlocked state when the safety bar is fastened.

### BACKGROUND ART

In general, a wheelchair refers to a means of transportation for a less able-bodied person, which is pushed by a person who is sitting down thereon or by an assistant from behind.

Since a user who needs the wheelchair is the less able-bodied person, it is very dangerous at a moment when s/he sits down on or stands up from the wheelchair. The wheelchair can move while the user is sitting down on or standing up from the wheelchair, and thus often cause accidents where the user gets hurt from a fall.

In particular, a person who rides a wheelchair is uncomfortable, and thus, a fall accident often leads to a major injury.

To solve the foregoing problems, there has been developed a wheelchair with a brake. However, a conventional wheelchair brake system still has a problem of causing the fall accidents since artificial control is needed to actuate the brake of the wheelchair like that of a bicycle.

### DISCLOSURE

### Technical Problem

The present invention is conceived to solve the foregoing problems, and an aspect of the present invention is to provide a wheelchair brake system which is in a brake lock mode to stop if no one sits down on a wheelchair, but releases a brake to move only if a user properly sits down on the wheelchair, thereby preventing a user from getting hurt from a fall due to movement of the wheelchair at a moment when the user sits down on and stands up from the wheelchair.

The present invention is conceived to solve the foregoing problems, and the present invention maintains the brake in a locked state in that a person is in a state of getting on or off a wheelchair when the safety bar is not fastened. Further, when the safety bar is fastened, the brake is switched from the locked state to the released state in that the person is in a state in which it is possible to move after boarding the wheelchair. Accordingly, an object of the present invention is to provide a fall prevention safety wheelchair brake device capable of preventing a fall accident in advance when moving a wheelchair and getting on and off a wheelchair by interlocking a safety bar and a brake.

### Technical Solution

A fall prevention safety wheelchair brake device comprises a safety bar unit which includes a safety bar configured as a pair and is fastened or separated while rotating vertically from the outside of the wheelchair to the center (or vice versa); a brake unit which is configured as a pair to correspond to the safety bar, and is interlocked with the operation of the safety bar unit.

And in a state in which the safety bar is not fastened, the brake is in a locked state, and when the safety bar is rotated and the safety bar is fastened, the brake is controlled to switch to a released state.

The safety bar unit comprises a fixed frame; a safety bar that is coupled to one end of the fixing frame and rotates vertically around one end of the fixed frame, which is a rotation axis and is fastened or separated according to the vertical rotation; a rotating member which is mounted inside the fixing frame and the safety bar and rotating integrally with the rotation of the safety bar.

The safety bar comprises a rotating end which is rotatably coupled to one end of the fixing frame, and is configured to be bent vertically with the fixing frame; and an arm which is extend from the other end bent vertically of the rotation end.

And a protrusion is formed at one end of the arm, and a receiving groove is formed at the rotating end, so that the protrusion of the arm is inserted into and coupled to the receiving groove of the rotating end, and the arm can be folded parallel to the fixing frame in a horizontal direction.

The rotating member is mounted inside the rotating end and the fixing frame, and the other end of it has a brake connecting end protruded outside the fixing frame.

One end of the rotating member is integrally coupled with the rotating end, but since it is coupled in a form that passes through the fixed frame, when the rotating end 112 is rotated, the rotating member also rotates, but the fixing frame is maintained in a fixed state.

The brake unit includes a brake pressurizing the wheelchair wheel or spaced apart from the wheel, crank connected between the brake and the brake coupling end of the rotating member protruding outside the fixing frame.

When the rotating member rotates, the crank is displaced, and the brake is switched to a locked state pressing the wheel or a released state spaced apart from the wheel.

One end of the brake is fixedly fastened to the extension end extending downward from the fixing frame, and the other end of the brake is fastened to the crank, according to the displacement of the crank, the one end acts as a rotation axis, and the other end is displaced, so that the brake is controlled to contact (the locked state) or spaced apart from the wheel (the released state).

When the arm of the safety bar is rotated forward to the outside of the wheelchair and the safety bar is separated, the brake is set to be in contact with the wheel of the wheelchair and maintained in a locked state.

And when the arm is rotated in the reverse direction to the center of the wheelchair to fasten the safety bar, the rotating member integrally rotating with the arm also rotates in the reverse direction, and the crank is displaced according to the rotation of the rotating member, so that the brake is separated from the wheel and is switched to a released state.

### Advantageous Effects

As described above, the fall prevention safety wheelchair brake device according to the present invention maintains the brake in a locked state in that the wheelchair is in a state in which the wheelchair is stationary and a person is getting on or off the wheelchair when the safety bar is not fastened, When the safety bar is fastened, the brake is switched from the locked state to a released state in that in which it is possible to move after boarding the wheelchair. Accordingly, the present invention has an excellent effect of preventing a fall accident in advance when moving a wheelchair and getting on and off the wheelchair by interlocking the safety bar (installed to safely move the occupant in the wheelchair) and the brake

### DESCRIPTION OF DRAWINGS

FIG. 1 schematically shows a wheelchair equipped with a safety wheelchair brake device for preventing falls according to a preferred embodiment of the present invention.

FIG. 2 is a schematic diagram of a device configuration of a brake device for preventing a fall from a safety wheelchair of FIG. 1.

FIG. 3 schematically shows the arm of FIG. 2,

FIG. 4 schematically shows the rotating end of FIG. 2.

FIG. 5 is an exploded perspective view of a safety wheelchair brake device for preventing falls according to a preferred embodiment of the present invention.

FIG. 6 schematically shows the operation of the fall prevention safety wheelchair brake device according to a preferred embodiment of the present invention.

### BEST MODE

The fall prevention safety wheelchair brake device according to the present invention may include a safety bar unit 10 and a brake unit 20. The safety bar unit includes a safety bar configured as a pair, and the safety bar can be fastened or separated while rotating vertically from the outside of the wheelchair to the center (or vice versa). The brake unit is configured as a pair to correspond to the safety bar, and is interlocked with the operation of the safety bar unit. In a state in which the safety bar is not fastened, the brake is in a locked state, and when the safety bar is rotated and the safety bar is fastened, the brake is controlled to switch to a released state.

### MODE FOR INVENTION

Below, embodiments of the present invention will be described in detail with reference to the accompanying drawings.

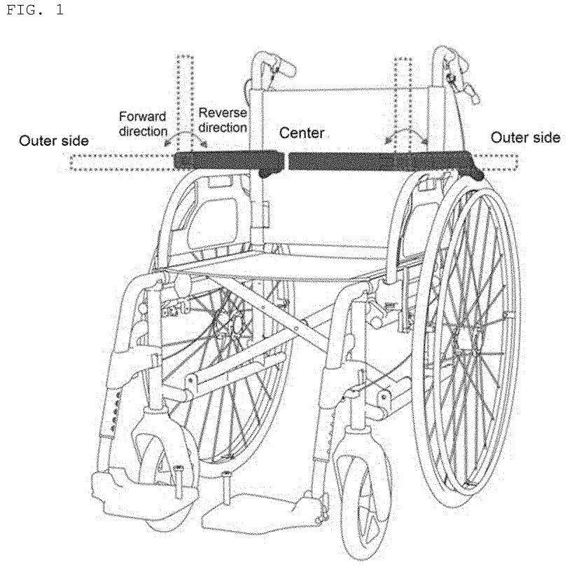

FIG. 1 schematically shows a wheelchair equipped with a safety wheelchair brake device for preventing falls according to a preferred embodiment of the present invention.

Referring to FIG. 1, the safety wheelchair brake for preventing falls according to the present invention has a structure in which a safety bar (for safety of a occupant when the wheelchair is moved) and a brake are interlocked, and it is characterized in that the brake is switched to release and lock according to the fastening and separation of the safety bar.

Therefore, before the occupant boards the wheelchair, the brake is maintained in the locked state when the safety bar is not fastened. Accordingly, the present invention can prevent the wheelchair from moving while the occupant sits or stands in the wheelchair, and prevents a fall accident that may occur when the wheelchair is pushed or moved when getting on and off the wheelchair.

In addition, after the occupant safely sits in the wheelchair and fastens the safety bar, the brake is switched from the locked state to the released state, and the wheelchair is controlled to move. Therefore, in order for the wheelchair to move, the occupant must fasten the safety bar, so the present invention can ensure the fastening of the safety bar before moving.

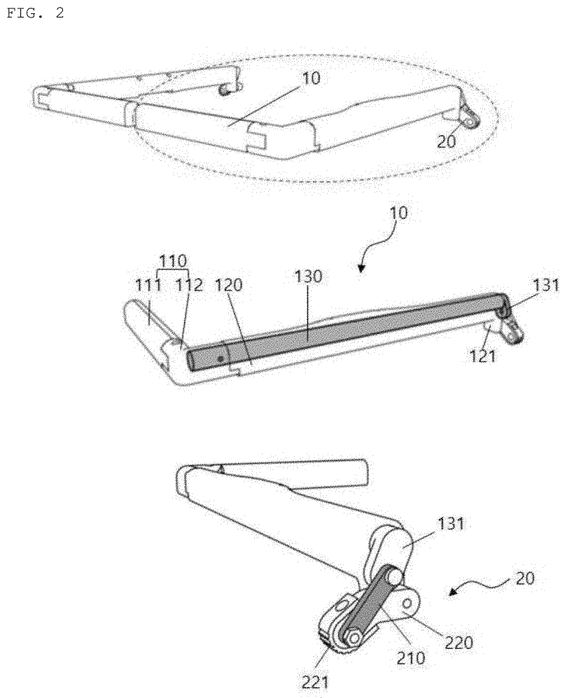

FIG. 2 is a schematic diagram of a device configuration of a brake device for preventing a fall from a safety wheelchair of FIG. 1.

Referring to FIG. 1, the fall prevention safety wheelchair brake device according to the present invention may include a safety bar unit 10 and a brake unit 20. The safety bar unit includes a safety bar configured as a pair, and the safety bar can be fastened or separated while rotating vertically from the outside of the wheelchair to the center (or vice versa). The brake unit is configured as a pair to correspond to the safety bar, and is interlocked with the operation of the safety bar unit. In a state in which the safety bar is not fastened, the brake is in a locked state, and when the safety bar is rotated and the safety bar is fastened, the brake is controlled to switch to a released state.

The safety bar unit 10 include a fixing frame 120; a safety bar 110 coupled to one end of the fixing frame in a vertical direction and fastening or separating according to a vertical rotation; a rotating member 130 mounted inside the fixing frame and the safety bar and rotating integrally with the rotation of the safety bar.

The safety bar 110 includes a rotating end 112 and an arm 111. The rotating end is rotatably coupled to the fixing frame at one end, and is configured in a “┐” shape to be bent vertically with the fixing frame. The arm is extend from the other end bent vertically of the rotation end, and is configured to can be folded in parallel with the fixing frame.

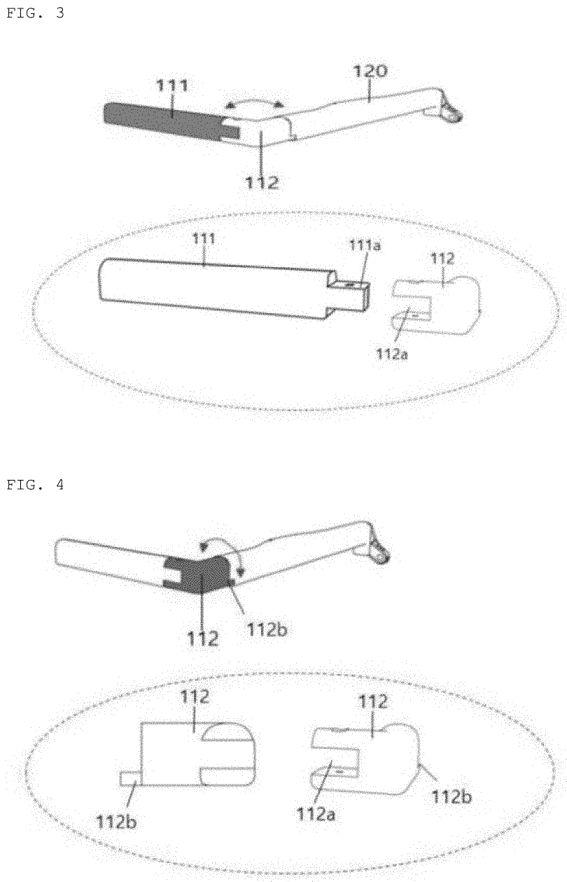

A protrusion 111a is formed at one end of the arm 111, and a receiving groove 112a is formed at the rotating end 112. The protrusion 111a of the arm may be inserted into the receiving groove 112a of the rotating end and coupled by a pin. Accordingly, while the rotating end 112 rotates in a vertical direction, the arm 111 may be folded parallel to the fixing frame 120 in a horizontal direction as shown in FIG. 3.

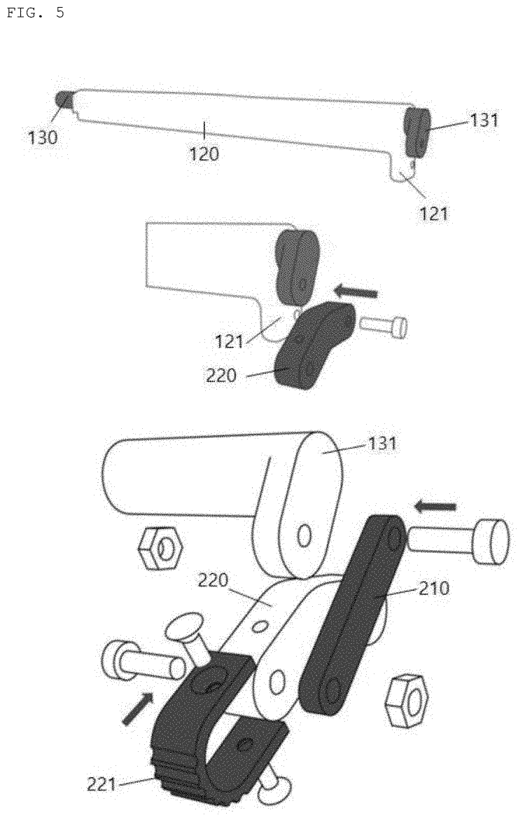

As shown in FIG. 4, the coupling end of the fixing frame 120 becomes a rotating shaft, and the rotating end 112 rotates the arm 111 in a vertical direction. Accordingly, the two arms are controlled to be fastened so that the safety bar is fastened or to be separated toward the outside of the wheelchair.

Here, one end of the rotating end 112 in contact with the fixing frame 120 may further include a stopper 112b for restricting the rotation so that the rotating end is not easily rotated when the safety bar is fastened

The rotating member 130 is mounted inside the rotating end 112 and the fixing frame 120, and rotates integrally while the rotating end 112 rotates according to the rotation of the arm 111.

One end of the rotating member 130 is accommodated in the rotating end 112, and the other end has a brake connecting end 131 protruding out of the fixing frame 120.

One end of the rotating member 130 is integrally coupled with the rotating end 112, but since it is coupled in a form that passes through the fixed frame, when the rotating end 112 is rotated, the rotating member 130 also rotates. However, the fixing frame 120 is maintained in a fixed state

On the other hand, the brake unit 20 may be configured to include a brake 220 pressurizing the wheelchair wheel or spaced apart from the wheel, crank 210 connected between the brake and the brake coupling end 131 of the rotating member protruding outside the fixing frame.

Here, the one end of brake 220 is fixedly fastened to the extension end 121 extending downward from the fixing frame 120, and the other end fastened to the crank 210. According to the displacement of the crank 210, the one end acts as a rotation axis, and the other end is displaced, so that the brake 220 is controlled to contact or spaced apart from the wheel.

Accordingly, when the rotating member 130 rotates, the crank 210 is displaced, and the brake 220, which was spaced apart from the wheel, is pressed while contacting the wheel, and is converted into a brake lock state. When the rotating member 130 rotates in the opposite direction, it may be operated to be separated from the wheel again to switch to a brake release state.

The outer periphery of the brake 220 may further include a serrated brake pad 221 to increase a friction force for braking the wheel.

Hereinafter, the operation of the safety wheelchair brake device for preventing falls according to a preferred embodiment of the present invention will be described.

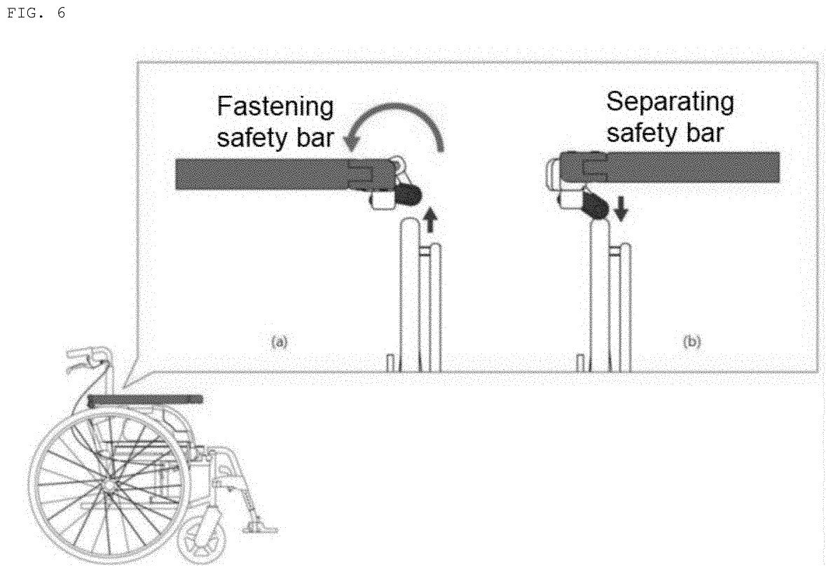

FIG. 6 schematically shows the operation of the fall prevention safety wheelchair brake device according to a preferred embodiment of the present invention.

Referring to FIG. 6, as shown in FIG. 6(b), when the safety bar is first separated, the brake is set to be kept in a locked state.

More specifically, when the arm 111 of the safety bar is rotated to the outside of the wheelchair and the safety bar is separated, the brake 220 of the brake unit connected to the rotating member 130 contacts the wheel of the wheelchair and maintains the brake locked state. It is set as possible. The direction in which the arm rotates from the center of the wheelchair to the outside is defined as a forward direction, and the direction in which the arm rotates from the outside of the wheelchair to the center is defined as the reverse direction.

Here, the arm may be horizontally folded parallel to the fixing frame in a state of being rotated outward.

As described above, when the safety bar is separated, the brake is locked and the wheelchair is stopped. Therefore, when the occupant gets on and off the wheelchair, the wheelchair does not move, so that the occupant of the wheelchair can safely get on and off.

And when the arm 111 is rotated toward the center of the wheelchair so that the two safety bars are fastened, the brake 220 is switched from the locked state to the released state.

More specifically, when the arm 111 is rotated to the center of the wheelchair to fasten the safety bar, the arm 111 rotates in the reverse direction. At this time, the rotating member 130 which rotates integrally with the arm 111 is also rotated in the reverse direction, and the crank 210 causes displacement according to the rotation of the rotating member 130.

Here, the brake 220 has one end fixedly fastened to the extension end 121 extending downward from the fixed frame 120, and the other end fastened to the crank 210. According to the displacement of the crank 210, the one end acts as a rotational shaft, the other end is displaced so that the brake 220 is separated from the wheel, and the brake is switched from the locked state to the released state.

Therefore, only when the safety bar is fastened, the brake is released so that the wheelchair can be moved.

In addition, when the safety bar is rotated from the fastened state to the separated state to get off the wheelchair, the brake is switched from the released state to the locked state so that the occupant can safely get on and off.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

### INDUSTRIAL APPLICABILITY

The present invention relates to a fall prevention safety wheelchair brake device, and more particularly, to a wheelchair having a safety bar for preventing safety accidents caused by falls while sitting on or standing up the wheelchair. In the present invention, when the safety bar is not fastened, the brake is in a locked state, and when the safety bar is fastened, the brake is switched from a locked state to an unlocked state, thereby preventing a fall accident. Therefore, the present invention is a very useful invention for the medical and health industries.

1. A fall prevention safety wheelchair brake device comprising:
a safety bar unit which includes a safety bar configured as a pair and is fastened or separated while rotating vertically from the outside of the wheelchair to the center (or vice versa);
a brake unit which is configured as a pair to correspond to the safety bar, and is interlocked with the operation of the safety bar unit;
wherein in a state in which the safety bar is not fastened, the brake is in a locked state, and when the safety bar is rotated and the safety bar is fastened, the brake is controlled to switch to a released state.

2. The fall prevention safety wheelchair brake device according to claim 1, wherein the safety bar unit comprises:
A fixed frame;
A safety bar that is coupled to one end of the fixing frame and rotates vertically around one end of the fixed frame, which is a rotation axis and is fastened or separated according to the vertical rotation;
a rotating member which is mounted inside the fixing frame and the safety bar and rotating integrally with the rotation of the safety bar.

3. The fall prevention safety wheelchair brake device according to claim 2, wherein the safety bar comprises:
a rotating end which is rotatably coupled to one end of the fixing frame, and is configured to be bent vertically with the fixing frame;
and an arm which is extend from the other end bent vertically of the rotation end;
wherein A protrusion is formed at one end of the arm, and a receiving groove is formed at the rotating end, so that the protrusion of the arm is inserted into and coupled to the receiving groove of the rotating end, and the arm can be folded parallel to the fixing frame in a horizontal direction.

4. The fall prevention safety wheelchair brake device according to claim 3, wherein the rotating member is mounted inside the rotating end and the fixing frame, and the other end of it has a brake connecting end protruded outside the fixing frame;
Wherein One end of the rotating member is integrally coupled with the rotating end, but since it is coupled in a form that passes through the fixed frame, when the rotating end 112 is rotated, the rotating member also rotates, but the fixing frame is maintained in a fixed state.

5. The fall prevention safety wheelchair brake device according to claim 2, wherein the brake unit includes:
a brake pressurizing the wheelchair wheel or spaced apart from the wheel,
crank connected between the brake and the brake coupling end of the rotating member protruding outside the fixing frame;
wherein when the rotating member rotates, the crank is displaced, and the brake is switched to a locked state pressing the wheel or a released state spaced apart from the wheel.

6. The fall prevention safety wheelchair brake device according to claim 5, wherein one end of the brake is fixedly fastened to the extension end extending downward from the fixing frame, and the other end of the brake is fastened to the crank, according to the displacement of the crank, the one end acts as a rotation axis, and the other end is displaced, so that the brake is controlled to contact (the locked state) or spaced apart from the wheel (the released state).

7. The fall prevention safety wheelchair brake device according to claim 6, wherein when the arm of the safety bar is rotated forward to the outside of the wheelchair and the safety bar is separated, the brake is set to be in contact with the wheel of the wheelchair and maintained in a locked state;
when the arm is rotated in the reverse direction to the center of the wheelchair to fasten the safety bar, the rotating member integrally rotating with the arm also rotates in the reverse direction, and the crank is displaced according to the rotation of the rotating member, so that the brake is separated from the wheel and is switched to a released state.
